(19) United States
(12) Patent Application Publication
(10) Pub. No.: US 2015/0058075 A1
(43) Pub. Date: Feb. 26, 2015

(54) SOCIAL NETWORK MARKETING

(71) Applicant: LEDULA WEB SERVICES (PTY) LTD, JOHANNESBURG (ZA)

(72) Inventor: Atholl Tomlinson, Jukskei Park (ZA)

(73) Assignee: LEDULA WEB SERVICES (PTY) LTD

(21) Appl. No.: 14/389,218

(22) PCT Filed: Apr. 4, 2013
(86) PCT No.: PCT/IB13/52696

§ 371 Date: Sep. 29, 2014

(30) Foreign Application Priority Data
Apr. 5, 2012 (ZA) 2012/02592

(51) Int. Cl. G06Q 30/02; G06Q 50/00

(52) U.S. Cl. CPC G06Q 30/02; G06Q 50/01
USPC 705/7.29

(57) ABSTRACT

A method of grouping business contacts based on social network user preferences which includes retrieving profile detail, including a social graph, of a primary social network user from an online social network, retrieving profile detail, including the social graph, of a secondary social network user from an online social network, storing the profile detail of the primary social network user and the secondary social network user in a database, defining a selection of the profile detail of any one or more of the primary social network user and the secondary social network user, and recommending the selection to a consumer.

THIS INVENTION relates to social network marketing. More particularly, the invention relates to a method of grouping business contacts based on social network user preferences. The invention also relates to a system of filtering business contacts based on the social network user preferences.

The invention is expected to be particularly advantageously applicable to local businesses that advertise on the Internet. Accordingly, such applications should particularly, but not exclusively, be borne in mind when considering this specification.

In this specification, the term business should be interpreted in a wide sense to include service providers, manufacturers, suppliers, hospitality providers such as hotels and restaurants, stores and the like, across many industry sectors.

### BACKGROUND OF THE INVENTION

A growing number of businesses rely on the Internet for promoting and advertising of their business offerings in order to increase revenues. Existing techniques include tailoring advertisements to target audiences and subsequently delivering advertisements to an appropriate target audience.

Many businesses leverage off Internet-based social networks such as Facebook® and LinkedIn® to establish their target audiences, however, the social networks focus on social exchange that is not necessarily relevant to commerce and business. Methods of utilizing user networks within network-based commerce platforms are well known and include identifying target customer groups by creating group association rules between social network users and communicating the results of the association rules to businesses in order to facilitate transactions between businesses and their target audiences.

The inventor has identified several drawbacks of existing methods of social network marketing over the Internet. Internet advertising is effective for global business and well-known brands who see a wide range of Internet users as potential customers. Such advertising often results in an overload of advertisements and associated information to potential customers. However, many businesses, in particular smaller businesses, have an inherently local contextual audience and may only be interested in advertising if their offerings are served to target audiences of local contextual interest. In particular the inventor identified a need to develop a system that would emulate the so called “word of mouth” advertising methods.

The present invention aims to improve focused delivery of business offerings to target audiences and reduce the overload of information to targeted customers.

### SUMMARY OF THE INVENTION

According to a first aspect of the invention there is provided a method of grouping business contacts based on social network user preferences which includes:

retrieving profile detail, including a social graph, of a primary social network user from an online social network;

retrieving profile detail, including the social graph, of a secondary social network user from an online social network;

storing the profile detail of the primary social network user and the secondary social network user in a database;

defining a selection of the profile detail of any one or more of the primary social network user and the secondary social network user; and

recommending the selection to a consumer.

It should be appreciated that the consumer may include any one or more of the primary and secondary social network users.

The phrase “social graph” should be understood to describe the relationships between social network users online, in contrast to the phrase “social network”, which describes relationships between social network users in the real world.

The secondary user may be known in the trade as any of a friend, connection, follower of the primary user and the like.

The profile detail of any of the primary and secondary social network users may include, but is not limited to, a business contact logically connected to any one or more of the primary and secondary social network users in the social network, and personal detail, such as login information, of the primary and secondary social network users.

The method may include retrieving the social graph from a social network such as Facebook®.

Storing of the profile detail in the database may include hosting the profile detail of the primary and secondary social network users on a database.

The method may include storing at least part of the social graph on the database.

The profile detail of any of the primary and secondary social network users may include a business contact recommendation. The business contact recommendation includes any one or more of a supplier recommendation, service provider recommendation and the like.

The method may include capturing of the profile detail, particularly the business contact recommendation, into the database and associating the captured business contact recommendation with any one or more of the primary user and secondary user.

Capturing of the business contact recommendation may include capturing the business contact recommendation by any one of retrieving the business contact recommendation from the social graph and capturing any one or more of the primary user's and secondary user's recommendation of a business contact into the database.

Capturing of the any one or more of the primary user's and secondary user's business contact recommendation into the database may include capturing any one of the primary and secondary user's recommendations via a software application interface of the database. The capturing may include the user's creation and modification of profile detail in the database, for example the user's introduction of a new business contact recommendation.

Preferably, capturing of any one or more of the primary user's and secondary user's recommendation may include capturing via a mobile application interface.

The method may include enabling any one or more of the primary social network user and the secondary social network user to rate the business contact recommendation and give a rating of the business contact recommendation.

Capturing of the any one or more of the primary user's and secondary user's business contact recommendation may include capturing the rating of the business contact recommendation into the database.

Recommending of the selection of the profile detail of the primary social network user and the secondary social network user to the consumer may include unsolicited recommendation of the selection to the consumer.

The method may include the consumer's requesting a suggestion of the selection of the profile detail from any one or more of the primary user and secondary user.

Hosting of the profile detail on the database server may include hosting the profile detail in a data warehouse. To this end, hosting of the profile detail in the data warehouse may include manipulating the profile detail in data warehouse organised fashion to provide speedy subsequent selection and provision of the profile detail to the consumer.

In keeping with the organisational structure of social networks, the primary and secondary social network users are logically organised into a hierarchical structure. Naturally, such a hierarchy may, in theory, include a limitless number of hierarchical levels of users.

Thus, in one embodiment of the invention, the method includes retrieving profile detail of a plurality of hierarchically lower-level social network users from the Internet-based social network, the lower-level users being referred to as friends of friends of the primary user. Consequently, the method includes storing the profile detail of the lower-level social network users in the database and recommending a selection of the profile detail of the primary social network user, secondary social network user and plurality of lower-level social network users to the consumer.

Recommending of the selection of the profile detail to the consumer may include offering the selection of profile detail via a front-end software application. Recommending of the selection of the profile detail via the software application may include offering the selection via a Web-based application. Naturally, offering of the selection of profile detail may include an offering via a front-end software application implemented on a mobile platform for accessing the database via a mobile device such as a mobile phone or smart phone.

Recommending of the selection of the profile detail to the consumer may include presenting the consumer with at least one selector of the profile detail which, in use, resembles a customisable filter of the profile detail.

Recommending of the selection of the profile detail may include providing the profile detail in address-book fashion.

At least one selector of the software application may be operable to render a selection of the profile detail hosted by the server, the selection being based on, yet not limited to, any one or more of at least one pre-determined business category and at least one pre-determined level of social network users. For example, in one embodiment, the consumer may be provided with functionality of generating the profile detail, i.e. the business contact recommendation, of friends of friends of the primary user within a consumer-specified pre-determined business category, for example a “home improvement” or “vehicle service” category.

Retrieving of the profile detail of any of the primary, secondary and lower-level social network users may include retrieving the profile detail across a variety of logically implemented Internet-based social networks. To this end, retrieval of the profile detail may require storing the login information of the social network users in the database and accessing the profile details across the variety of social networks by communicating the login information, such as a username and password, to the variety of social networks and prompting the social networks for their profile details.

It should be appreciated that the method of grouping business contacts as hereinbefore described may advantageously include offering a consumer a membership subscription service to retrieval of selections of the profile detail.

According to another aspect of the invention there is provided a system of filtering business contacts that implements the method of grouping business contacts based on social network user preferences.

The invention is now described, by way of non-limiting example, with reference to the accompanying diagrammatic drawings.

### DRAWINGS

In the drawings:

FIG. 1 shows, schematically and in accordance with one embodiment of the invention, an Internet-based social network on which a method of grouping business contacts based on social network user preferences including the social graph relies;

FIG. 2 shows, schematically, a method of grouping business contacts based on social network user preferences in accordance with another embodiment of the invention.

FIG. 3 shows, diagrammatically, a method of grouping business contacts in accordance with yet another embodiment of the invention.

In the drawings, like reference numerals denote like parts of the invention unless otherwise indicated.

### DETAILED DESCRIPTION OF THE INVENTION

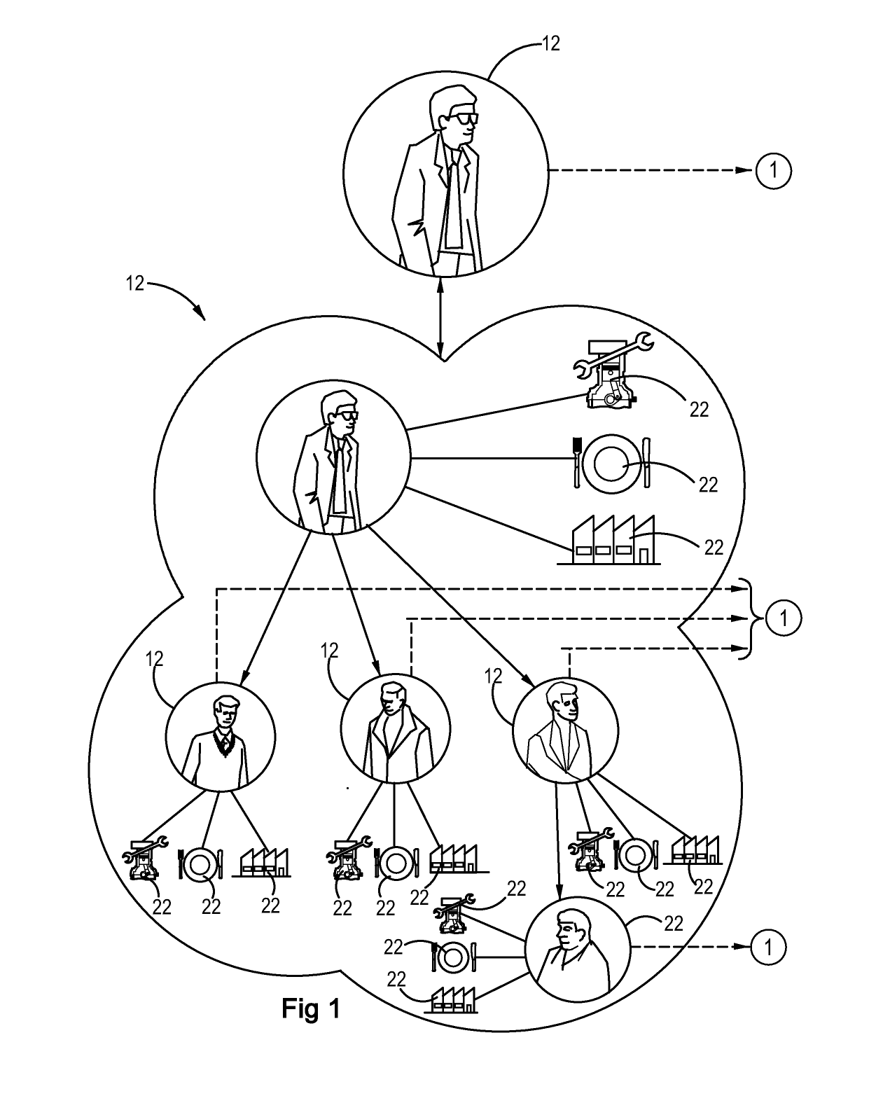

With reference to FIG. 1, reference numeral 10 denotes, generally, an Internet-based social network, for example Facebook®. The social network 10 has a number of user subscribers, of which a primary user is denoted by numeral 12 and secondary users are denoted by numerals 14, 16 and 18. In social networking terms, the secondary users 14, 16 and 18 are so-called “friends” of the primary user. The network 10 further includes an hierarchically lower-level user 20, the user 20 in turn being a so-called “friend” of the user 18.

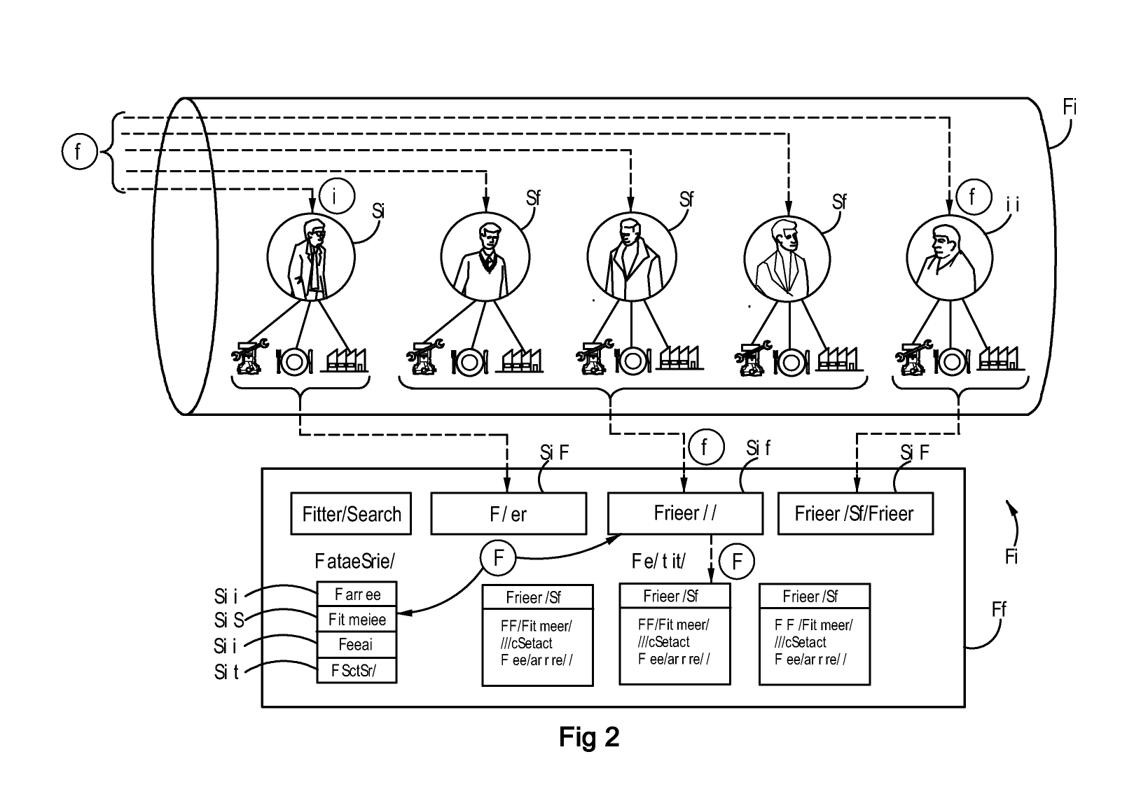

As part of the social network 10's functionality, each of the users 12, 14, 16, 18 and 20 are offered the capability of making certain recommendations of businesses or services which they have made use of. In this particular embodiment, the services and businesses in question are a restaurant 24, car service centre 22 and factory store outlet 26. The recommendations are stored in a database 52, as shown with reference to FIG. 2.

Turning to FIG. 2, reference numeral 50 denotes, generally, a system of grouping business contacts based on the social network user preferences. The system 50 includes the database 52, the database operable to store profile detail of the primary user 12 of FIG. 1, secondary users 14, 16 and 18, and the lower-level user 20 (a friend of user 12's friend, 18). In this embodiment, the profile detail includes login information (i.e. username and passwords) of the users 12, 14, 16, 18 and 20 and respective business contact recommendations, i.e. the restaurant 24, car service centre 22 and factory store outlet 26.

The system 50 provides a front-end, Web-based software application 54 operable to provide a consumer (not shown) with a selection of the profile details of the users, in particular the business recommendations 22, 24 and 26. Note here that the consumer is in fact the primary social network user. The front-end software application provides the consumer with the profile details in the form of a graphical user interface (GUI), and is logically connected to the database 52. In this particular embodiment of the invention, the front-end software application is implemented as a mobile application, thus allowing a consumer access to the database via a mobile application running on, say, a mobile telephone or smart phone. Naturally, the database 52 is hosted on a database server (not shown) which handles the organization and processing of the user profile details by implementing a data warehouse for speedy retrieval of queries to the database 52 from the front-end software application 54.

The method of grouping business contacts based on social network user preferences that is implemented by the system 50 of FIG. 2 begins with a step 1 at FIG. 1 of retrieving the primary user 12's profile detail, i.e. 22, 24 and 26 from the social network 10 by logging into the network 10 with the username and password of the primary user 12 which is stored in the database 52. The business recommendations of the primary user 12 is subsequently stored in the database 52 at step 2 in FIG. 2. Likewise, at step 3 in FIG. 1, the business recommendations 22, 24 and 26 of the secondary users 14, 16 and 18 are respectively retrieved by using their respective login information and the business recommendations are stored in the database 52 at step 4. The business recommendations by the lower-level user 20 (who is a friend of the secondary friend 18) are retrieved in similar fashion at step 5 and stored in the database 52 at step 6. The profile details, i.e. the business recommendations of the users 12, 14, 16, 18 and 20 are collectively hosted by the server of the database 52.

In use, a consumer of the method is provided with the functionality of selecting a pre-determined business category (buttons 100 through 103) at a pre-determined level of the social network (10) hierarchy via buttons 105 through 107. Thus, in use and at step no. 7 of the method, the particular category of business contact 101 is selected by the consumer in view of selecting those plumbers who have been recommended by only friends 14, 16 and 18 of the primary user 12. The latter selection is made by the consumer at step 8 in the method.

After selecting the relevant business category (100 through 103) and applying the selection to a pre-determined level of friends or lower-level users of the social network 10, the front-end software Web application retrieves the relevant information from the database 52 and renders a resultant selection to the consumer at step 9.

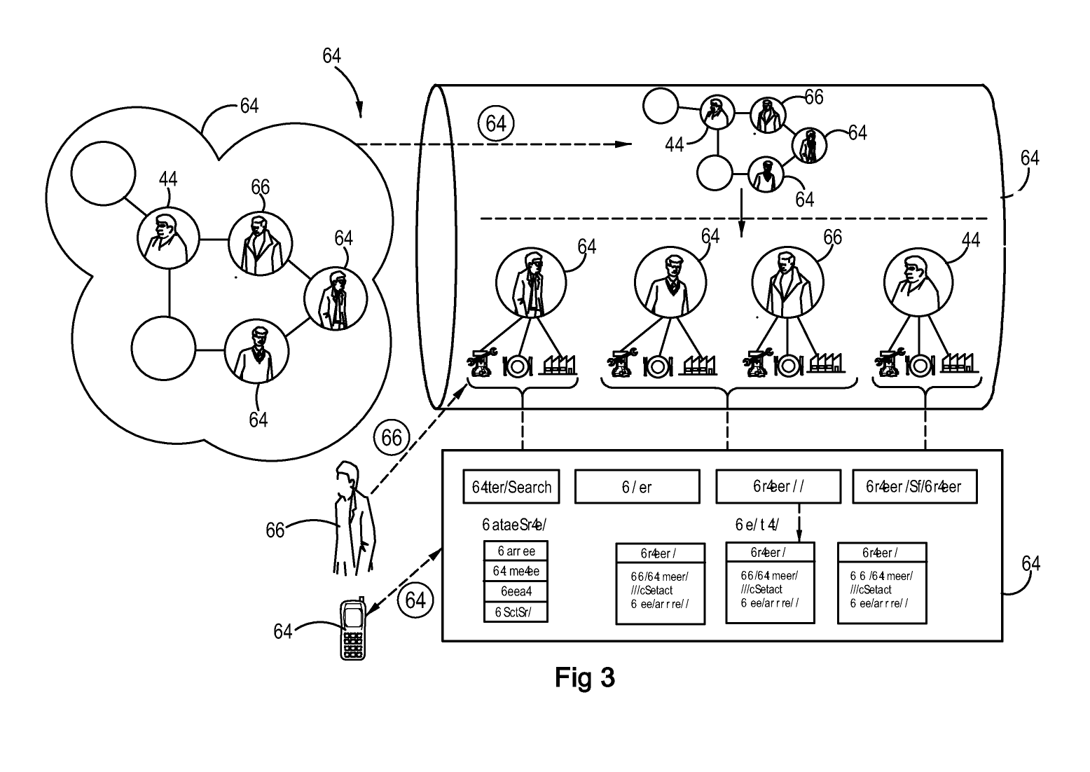

Referring now to FIG. 3 of the drawings, reference numeral 60 generally denotes a method of grouping business contacts based on social network user preferences in accordance with a preferred embodiment of the invention. Numeral 62 shows a social graph of the connectivity of the users of FIG. 1 as defined by a social network such as Facebook®. In contrast with the method illustrated by numeral 10 of FIG. 1, the profile details of the users are not taken from the social network. Instead, the connectivity between the primary user 12 and secondary users 14 and 16 is retrieved into the database 52 at step 64 and the business recommendations are captured by a consumer or user 65 into the database 52 via a mobile application interface 67 at step 66. The consumer or user may thus include the social network users 12, 14, 16 and 20, as well as a consumer that is not part of the social graph 62. In this embodiment, the recommendations are thus stored in a proprietary database distinct from that of the database hosting the actual social network (indicated by the social graph 62). At 68, the consumer 65 accesses the database 52 via a mobile, front-end software application 67. In this embodiment of the invention, it clearly shows that the database 52 hosts the social graph 62, the business contacts that users, such as user 65, capture into the database 52 and contact recommendations that users capture against business contacts.

Advantageously, a method of grouping business contacts based on social network user preferences reduces the number of contact items that users see by leveraging off a social network, thus exposing only contacts in a specific category that a user's friends and their friends have recommended. The information is presented in an address book style that may be shared with friends.

1. A method of grouping business contacts based on social network user preferences which comprises:
retrieving profile detail, including a social graph, of a primary social network user from an online social network;
retrieving profile detail, including the social graph, of a secondary social network user from an online social network;
storing the profile detail of the primary social network user and the secondary social network user in a database;
defining a selection of the profile detail of any one or more of the primary social network user and the secondary social network user;
storing the selection of profile detail in the database; and
recommending the stored selection to a consumer.

2. The method of grouping business contacts as claimed in claim 1 where the consumer includes the primary social network user.

3. A method of grouping business contacts as claimed in claim 2 of which the primary and secondary users are logically connected and organized in a hierarchy, and the profile detail of any of the primary and secondary social network users includes a business contact logically connected to the primary and secondary users based on the hierarchy.

4. The method of grouping business contacts as claimed in claim 3 wherein the primary and secondary users are known in the trade as friends, connections, followers, or a combination thereof.

5. The method of grouping business contacts as claimed in claim 4 wherein the hierarchy includes a plurality of hierarchical users.

6. The method of grouping business contacts as claimed in claim 5 further comprising retrieving the social graph from a social network.

7. The method of grouping business contacts as claimed in claim 6 wherein storing of the profile detail in the database includes hosting the profile detail of the primary and secondary social network users on the database.

8. The method of grouping business contacts as claimed in claim 7 wherein the profile detail of the primary and/or the secondary social network users includes a business contact recommendation.

9. The method of grouping business contacts as claimed in claim 8 where the business contact recommendation includes at least one supplier recommendation and at least one service provider recommendation.

10. The method of grouping business contacts as claimed in claim 9 further comprises the consumer requesting a suggestion of the selection of the profile detail from at least one primary user, at least one secondary user, or a combination thereof; wherein recommending of the selection of the profile detail of the primary social network user and the secondary social network user to the consumer includes unsolicited recommendation of the selection to the consumer.

11. (canceled)

12. The method of grouping business contacts as claimed in claim 10 further comprises enabling at least one primary social network user and at least one secondary social network user to rate the business contact recommendation and give a rating of the business contact recommendation.

13. The method of grouping business contacts as claimed in claim 12 wherein capturing of the business contact recommendation includes capturing the business contact recommendation by the consumer retrieving the business contact recommendation from the social graph and capturing any one or more of the primary user's and secondary user's recommendation of a business contact into the database.

14. The method of grouping business contacts as claimed in claim 13 wherein capturing of the at least one of the primary user's and secondary user's business contact recommendation includes capturing the rating of the business contact recommendation into the database.

15. The method of grouping business contacts as claimed in claim 14 wherein capturing of the at least one of the primary user's and secondary user's business contact recommendation into the database includes capturing at least one of the primary and secondary user's recommendations via a software application interface of the database.

16. The method of grouping business contacts as claimed in claim 15 wherein hosting of the profile detail on the database server further comprises hosting the profile detail in a data warehouse.

17. The method of grouping business contacts as claimed in claim 16 wherein recommending of the selection of the profile detail to the consumer further comprises offering the selection of profile detail via a front-end software application, web-based application, mobile device, or a combination thereof.

18. (canceled)

19. (canceled)

20. The method of grouping business contacts as claimed in any one of claims 17 wherein recommending of the selection of the profile detail to the consumer includes presenting the consumer with at least one selector of the profile detail which is a customizable filter of the profile detail, providing the profile detail in address-book fashion, or a combination thereof.

21. (canceled)

22. The method of grouping business contacts as claimed in claim 20 of which the at least one selector of the software application is operable to render a selection of the profile detail hosted by the server, the selection being based on at least one pre-determined business category and at least one pre-determined level of social network users.

23. A system of filtering business contacts that implements the method of grouping business contacts based on social network user preferences as claimed in claims 1.

24. (canceled)

25. (canceled)
